(19) United States
(12) Patent Application Publication
(10) Pub. No.: US 2023/0021016 A1
(43) Pub. Date: Jan. 19, 2023

(54) HYBRID OBJECT DETECTOR AND TRACKER

(71) Applicant: QUALCOMM Incorporated, San Diego, CA (US)

(72) Inventors: Wen-Chun FENG, New Taipei City (TW); Hui Shan KAO, New Taipei City (TW); Jian-Jia SU, Changhua (TW)

(21) Appl. No.: 17/647,558

(22) Filed: Jan. 10, 2022

Related U.S. Application Data
(60) Provisional application No. 63/218,864, filed on Jul. 6, 2021.

(51) Int. Cl. G06T 7/80; G06K 9/62; G06T 7/20; G06V 10/25; G06T 7/10; H04N 5/235; G06T 7/60

(52) U.S. Cl. CPC G06T 7/80; G06K 9/6262; G06T 7/20; G06V 10/25; G06T 7/10; H04N 5/2351; G06T 7/60

(57) ABSTRACT

Systems and techniques described herein relate to techniques for improving image detection. In some examples, aspects relate to systems and techniques for improving image detection by performing tracking of objects within captured image frames. A process can include obtaining, from an image capture device, a first image frame including an object. The process can further include determining, using an object detector, an object validation score associated with detection of the object in the first image frame, and determining the object validation score is less than a validation threshold. Based on the object validation score being less than the validation threshold, the process can include tracking the object for one or more image frames received subsequent to the first image frame.

### CROSS-REFERENCE TO RELATED APPLICATIONS

The present application claims the benefit of U.S. Provisional Application No. 63/218,864, filed Jul. 6, 2021, entitled “HYBRID OBJECT DETECTOR AND TRACKER,” which is hereby incorporated by reference in its entirety and for all purposes.

### FIELD

This application is related to image processing. In some examples, aspects of the application relate to systems and techniques for improving image detection and tracking performed on image data within captured image frames.

### BACKGROUND

Some camera systems can be configured to automatically process image data, for example, to perform object identification to determine the location/placement regions of interest (e.g., bounding boxes) within a captured image. In practice, regions of interest may be used to identify the location of specific objects or object features, such as identifying the location of faces within captured image frames. More advanced and accurate image processing techniques are needed to improve the accuracy of bounding box placement, particularly in implementations in which object identification and/or tracking are performed across multiple image frames in which image clarity and/or object visibility are changing.

### SUMMARY

Systems and techniques are described herein for improving image processing (e.g., image detection operations), for example, that are performed to detect/identify image objects within captured image frames. More specifically, aspects of the disclosed technology improve on conventional object detection approaches (e.g., that utilize computer-vision (CV) and/or artificial intelligence (AI)/machine learning (ML) based approaches to perform object identification), by utilizing tracking algorithms to improve the object detection process, thereby producing more steady detections results.

In some aspects, the systems and techniques can utilize an object controller (e.g., including a detector analyzer, a tracker controller, and an object processor) to determine when the object detection process may benefit from the invocation of a tracking algorithm. In some cases, the invocation of a tracking algorithm may be determined based on one or more characteristics of the captured image frame. In one illustrative example, invocation of the tracking algorithm can be based on a validation score that is determined (or calculated) for a given image frame. By comparing the validation score to a validation threshold, the systems and techniques can determine whether to invoke a tracking algorithm to perform object tracking of an object for one or more subsequently received image frames. As discussed in further detail herein, the validation score for a given image frame can be based on one or more characteristics (e.g., size, location, confidence, and/or motion vector information, etc.) for one or more objects in the image frame. Additionally, one or more thresholds that are used to invoke tracking may be automatically and/or dynamically determined, for example, based on image characteristics, such as lighting parameters, etc.

According to at least one example, a method of processing image data is provided. The method can include: obtaining, from an image capture device, a first image frame comprising an object; determining, using an object detector, an object validation score associated with detection of the object in the first image frame; determining the object validation score is less than a validation threshold; and based on the object validation score being less than the validation threshold, tracking the object for one or more image frames received subsequent to the first image frame.

In another example, an apparatus for processing image data is provided. The apparatus can include at least one memory and at least one processor (e.g., implemented in circuitry) coupled to the at least one memory. The at least one processor is configured to: obtain, from an image capture device, a first image frame comprising an object; determine, using an object detector, an object validation score associated with detection of the object in the first image frame; determine the object validation score is less than a validation threshold; and based on the object validation score being less than the validation threshold, track the object for one or more image frames received subsequent to the first image frame.

In another example, a non-transitory computer-readable medium is provided that has stored thereon instructions that, when executed by one or more processors, cause the one or more processors to: obtain, from an image capture device, a first image frame comprising an object; determine, using an object detector, an object validation score associated with detection of the object in the first image frame; determine the object validation score is less than a validation threshold; and based on the object validation score being less than the validation threshold, track the object for one or more image frames received subsequent to the first image frame.

In another example, an apparatus for processing image data is provided. The apparatus includes: means for obtaining, from an image capture device, a first image frame comprising an object; means for determining, using an object detector, an object validation score associated with detection of the object in the first image frame; means for determining the object validation score is less than a validation threshold; and means for tracking, based on the object validation score being less than the validation threshold, the object for one or more image frames received subsequent to the first image frame.

In some aspects, the method, apparatuses, and computer-readable medium described above can include comparing, using a detector analyzer, the object validation score to the validation threshold, wherein determining the object validation score is less than the validation threshold is based on the comparison.

In some aspects, the method, apparatuses, and computer-readable medium described above can include: obtaining a second image frame comprising the object or an additional object; determining an additional object validation score associated with detection of the object or the additional object in the second image frame is greater than the validation threshold; and based on the additional object validation score being greater than the validation threshold, processing the second image frame based on detection of the object.

In some aspects, the method, apparatuses, and computer-readable medium described above can include adjusting a setting of the image capture device based on the first image frame and a tracking output based on tracking of the object. In some examples, the setting is adjusted based on a region of interest (ROI) associated with the object. In some cases, the ROI is based on tracking the object for the one or more image frames. In some cases, the ROI is based on detection of the object in the first image frame. In some examples, the setting is adjusted based on a first region of interest (ROI) associated with the object and a second ROI associated with the object. In some cases, the first ROI is based on tracking the object for the one or more image frames and the second ROI is based on detection of the object in the first image frame. Alternatively or in addition, in some examples, the setting includes at least one of an auto-focus setting, an auto-exposure setting, and an auto-white-balance setting. Alternatively or in addition, in some examples, the setting includes a segmentation process.

In some aspects, the object validation score is based on at least one of a size of the object in the first image frame and a distance of the object from a center of the first image frame.

In some aspects, the validation threshold is automatically configured based on one or more image properties associated with the first image frame. In some cases, the one or more image properties include an image brightness level.

In some aspects, one or more of the apparatuses described above is or is part of a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, a vehicle (e.g., a computing device of a vehicle), or other device. In some aspects, an apparatus includes a camera or multiple cameras for capturing one or more images. In some aspects, the apparatus further includes a display for displaying one or more images, notifications, and/or other displayable data. In some aspects, the apparatus can include one or more sensors, which can be used for determining a location and/or pose of the apparatus, a state of the apparatuses, and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a block diagram illustrating an example architecture of an image capture and processing system, in accordance with some examples;

FIG. 2 is a block diagram illustrating an example architecture of a hybrid object detector and tracker, according to some aspects of the disclosed technology;

FIGS. 3A and 3B illustrate examples in which a detector analyzer can be used to produce a validation score based on different image characteristics, according to some aspects of the disclosed technology;

FIG. 4 conceptually illustrates an example of how dynamic threshold assignments can be performed using a tracker controller, according to some aspects of the disclosed technology;

FIG. 5A illustrates examples of how region of interest (ROI) outputs can be used by the object processor, depending on the information provided by the detector analyzer and/or the tracker controller, according to some aspects of the disclosed technology;

FIGS. 5B and 5C illustrate examples of region of interest (ROI) outputs generated by an object processor using a conventional tracking system, and a hybrid object detection and tracking system, respectively;

FIG. 6 illustrates steps of an example process for implementing a hybrid object detection and tracking system, according to some aspects of the disclosed technology;

FIG. 7 is a diagram illustrating an example of the Cifar-10 neural network, in accordance with some examples;

FIG. 8A-FIG. 8C are diagrams illustrating an example of a single-shot object detector, in accordance with some examples;

FIG. 9A-FIG. 9C are diagrams illustrating an example of a you only look once (YOLO) detector, in accordance with some examples; and

FIG. 10 is a diagram illustrating an example of a system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

A camera is a device that receives light and captures image frames, such as still images or video frames, using an image sensor. The terms “image,” “image frame,” and “frame” are used interchangeably herein. Cameras may include processors, such as image signal processors (ISPs), that can receive one or more image frames and process the one or more image frames. For example, a raw image frame captured by a camera sensor can be processed by an ISP to generate a final image. Processing by the ISP can be performed by a plurality of filters or processing blocks being applied to the captured image frame, such as denoising or noise filtering, edge enhancement, color balancing, contrast, intensity adjustment (such as darkening or lightening), tone adjustment, among others. Image processing blocks or modules may include lens/sensor noise correction, Bayer filters, de-mosaicing, color conversion, correction or enhancement/suppression of image attributes, denoising filters, sharpening filters, among others.

Cameras can be configured with a variety of image capture and image processing operations and settings. The different settings result in images with different appearances. Some camera operations are determined and applied before or during capture of the photograph, such as auto-focus, auto-exposure, and auto-white-balance algorithms (collectively referred to as the “3As”). Additional camera operations applied before or during capture of a photograph include operations involving ISO, aperture size, f/stop, shutter speed, and gain. Other camera operations can configure post-processing of a photograph, such as alterations to contrast, brightness, saturation, sharpness, levels, curves, or colors.

In many camera systems, a user may direct or initiate an image processing operation. For instance, a camera device may display, to the user, a series of image frames when operating in an image-capture mode. The displayed image frames may be referred to or included in a “preview stream.” The camera device may update the image frames in the preview stream periodically and/or as the user moves the camera device. While viewing an image frame in a preview stream, the user may select a portion of the image frame corresponding to a desired location for an image processing operation to be performed. For example, if the camera is equipped with a touch screen or other type of interface configured for user input, the user may select (e.g., with a finger, stylus, or other suitable input mechanism) a location (such as one or more pixels) of the image frame. Non-limiting examples of suitable user input include double-tapping a location within a display and pressing down a location within a display for a predetermined amount of time (e.g., half a second, one second, etc.). In some cases, the location may include or correspond to an object of interest (e.g., a main subject or focal point) within the image frame. The camera device may perform an image processing operation on a region of the image frame surrounding and/or encompassing the selected location. This region may be referred to as a “region of interest” (ROI). In some implementations, the ROI may be indicated by a visual feature, such as a box, referred to as a bounding box.

As will be explained in greater detail below, conventional image processing systems may perform image processing operations to identify one or more ROIs within an image frame using an object detector, such as by using a computer-vision (CV) or machine-learning (ML) based detector. However, in such implementations, accurate placement of the ROIs (e.g., the bounding boxes) can be difficult if the objects are not easily visible within the image frame. In some examples, one or more ROIs may be difficult to identify in an image frame for a given object if the view angle of the object is poor, if the object is occluded in the frame, or if the image quality is poor (e.g., if the image is too bright or too dark). In one example, if the view angle of a person's face in an image frame is from a profile point of view (from the side of the face), from a top perspective point of view (look down at the face), from a bottom perspective point of view (looking up at the face), certain features of the face may not be visible in the image frame, which can prevent face detection from detected the face and thus make it difficult or impossible to determine an ROI corresponding to the face.

Systems, apparatuses, processes, and computer-readable media (collective referred to herein as “systems and techniques”) are described herein for improving object detection. For instance, in some examples, a hybrid object detector and tracker can identify dynamic ROIs by enhancing object detection using one or more tracking algorithms. The hybrid object detector and tracker can combine any existing object detector and tracking algorithm to obtain high quality detection results. For example, an object tracking engine of the hybrid object detector and tracker system can perform object tracking to track an object or portion of the object (e.g., a face of a person), such as when object detection fails (e.g., when a view of an object is poor, such as from a top perspective point of view). Using tracking to assist with object detection the systems and techniques can accurately identify changing locations of ROIs across multiple successive image frames.

In some cases, an object controller of a hybrid object detector and tracker system can be used to determine when to perform object tracking. For instance, the object controller can determine a quality of an object detection result for an image frame (e.g., whether the object detection result is valid or invalid). In some cases, the object controller can determine the quality of the object detection result based on an ROI and/or a confidence of the object detection result. Based on the quality of the object detection result, the object controller can determine whether to invoke a tracking engine to (e.g., via a tracker controller in some cases) to perform object tracking for the image frame. In some examples, in the event the object tracking engine is invoked to perform object tracking, the result of the tracking can be used to determine a location or position of an ROI in the image frame. Based on the location of the ROI in the image frame, the system can perform an image processing operation, such as autoexposure, auto-white balance, autofocus (referred to as 3A), auto-zoom, blurring a region of the image frame outside of the ROI (which can be referred to as bokeh, such as portrait bokeh), and/or other operation.

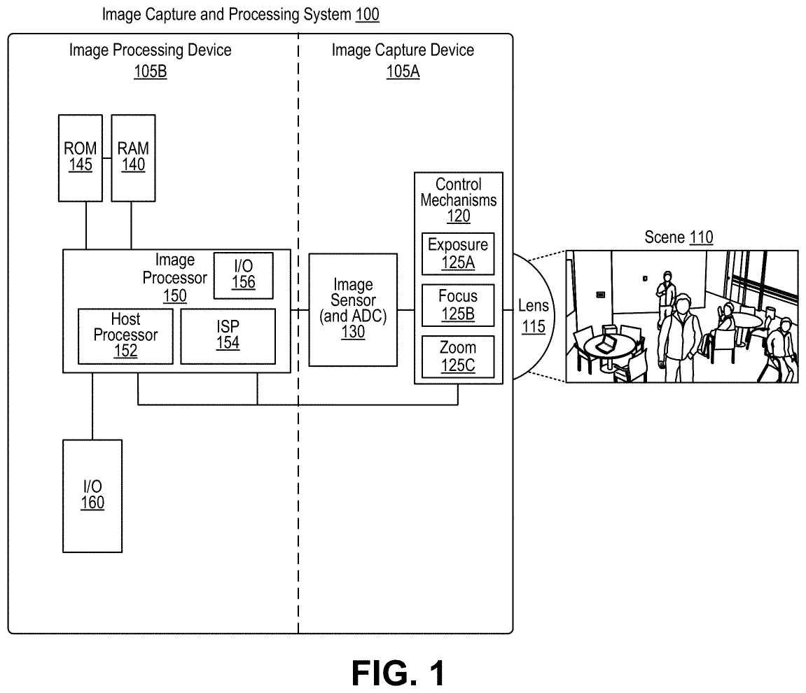

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties. In some cases, the one or more control mechanisms 120 may control and/or implement “3A” image processing operations.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the device 105A, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 1010 discussed with respect to the computing system 1000. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1020, read-only memory (ROM) 145/1025, a cache 1012, a memory unit 1015, another storage device 1030, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1035, any other input devices 1045, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the device 105B and one or more peripheral devices, over which the device 105B may receive data from the one or more peripheral device and/or transmit data to the one or more peripheral devices. The I/O 160 may include one or more wireless transceivers that enable a wireless connection between the device 105B and one or more peripheral devices, over which the device 105B may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

The host processor 152 can configure the image sensor 130 with new parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames. The host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. The settings of different modules of the ISP 154 can be configured by the host processor 152. Each module may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

In some cases, the image capture and processing system 100 may perform one or more of the image processing functionalities described above automatically. For instance, one or more of the control mechanisms 120 may be configured to perform auto-focus operations, auto-exposure operations, and/or auto-white-balance operations (referred to as the “3As,” as noted above). In some embodiments, an auto-focus functionality allows the image capture device 105A to focus automatically prior to capturing the desired image. Various auto-focus technologies exist. For instance, active autofocus technologies determine a range between a camera and a subject of the image via a range sensor of the camera, typically by emitting infrared lasers or ultrasound signals and receiving reflections of those signals. In addition, passive auto-focus technologies use a camera's own image sensor to focus the camera, and thus do not require additional sensors to be integrated into the camera. Passive AF techniques include Contrast Detection Auto Focus (CDAF), Phase Detection Auto Focus (PDAF), and in some cases hybrid systems that use both. The image capture and processing system 100 may be equipped with these or any additional type of auto-focus technology.

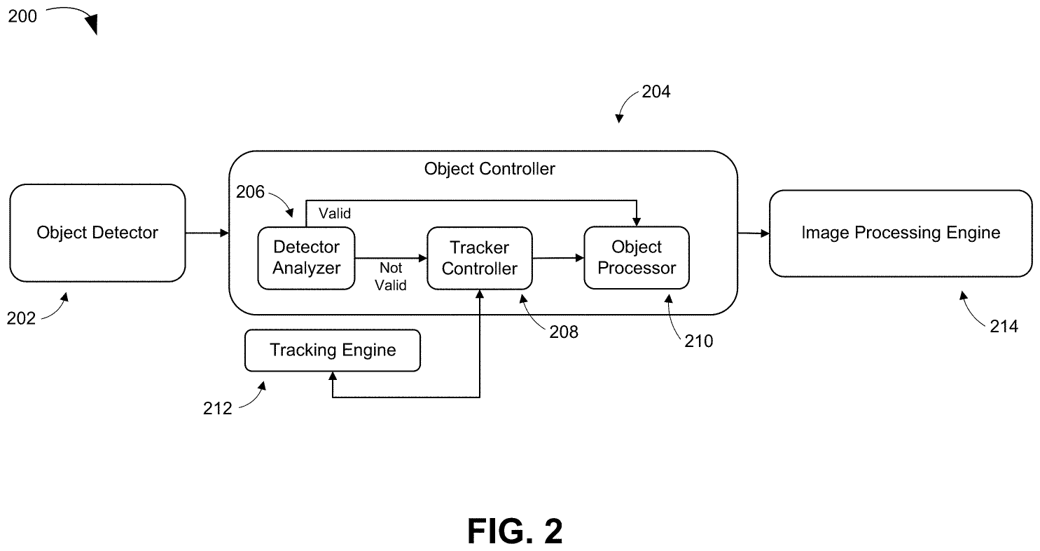

FIG. 2 is a block diagram illustrating an example architecture of a hybrid object detector and tracker system 200, according to some aspects of the disclosed technology. The hybrid object detector and tracker system 200 can combine any existing object detector and tracking algorithm to obtain quality detection results, as described herein. As shown in FIG. 2, the hybrid object detector and tracker system 200 includes an object detector 202. The object detector 202 is configured to detect (e.g., identify and/or classify) objects of interest in one or more image frames (also referred to as images or frames). For example, objects of interest may include faces (e.g., for facial recognition or tracking), vehicles (e.g., for autonomous driving, vehicle safety, vehicle-to-everything (V2X) communications, and/or other vehicular uses), or may include other types of objects or image features in one or more image frames. Based on the detection of one or more objects of interest in an image frame, the object detector 202 can output a detection or classification output. In some examples, the detection or classification output can include information indicating a region of interest or ROI (e.g., a bounding region, such as a bounding box) associated with a detected object or portion of the object, a confidence level or score corresponding to the detected object or portion of the object, and/or other information. In some implementations, a confidence level or score can include a value between 0 and 1 (e.g., within an interval of [0, 1]), with a confidence level/score closer to 0 indicating a lower confidence that an object is accurately detected and a confidence level/score closer to 1 indicating a higher confidence that an object is accurately detected. Additionally or alternatively, in some cases, the detection or classification output can include a size of the ROI (e.g., bounding box or other bounding region) associated with an object detected in the image frame, a location of the ROI within the image frame in which the corresponding object is detected, and/or motion vector information associated with the object associated with the ROI. Additionally or alternatively, in some cases, the detection or classification output can include a class associated with a detected object (e.g., a face, a vehicle, or other classification).

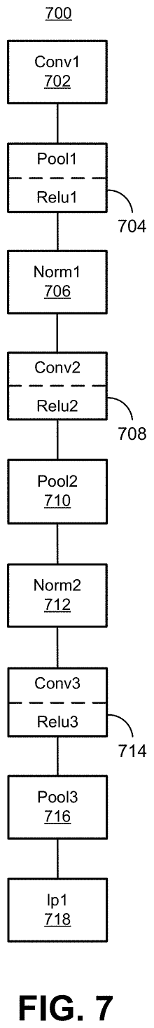

The object detector 202 may be implemented using a computer-vision (CV)-based detector, a machine-learning (ML) model (e.g., that is configured to identify/classify specific classes of image features, such as faces, vehicles, etc.), and/or other type of object detector. In some examples, the object detector 202 can be configured as an object detector configured to detect objects in image frames, a face detector configured to detect faces of people in image frames, a saliency detector configured to detect the most salient regions or objects within image frames, etc. In one example, the object detector 202 can use any suitable neural network-based detector. One example includes a Cifar-10 neural network-based detector. FIG. 7 is a diagram illustrating an example of the Cifar-10 neural network 700. In some cases, the Cifar-10 neural network can be trained to classify persons and cars only. As shown, the Cifar-10 neural network 700 includes various convolutional layers (Conv1 layer 702, Conv2/Relu2 layer 708, and Conv3/Relu3 layer 714), numerous pooling layers (Pool1/Relu1 layer 704, Pool2 layer 710, and Pool3 layer 716), and rectified linear unit layers mixed therein. Normalization layers Norm1 706 and Norm2 712 are also provided. A final layer is the ip1 layer 718.

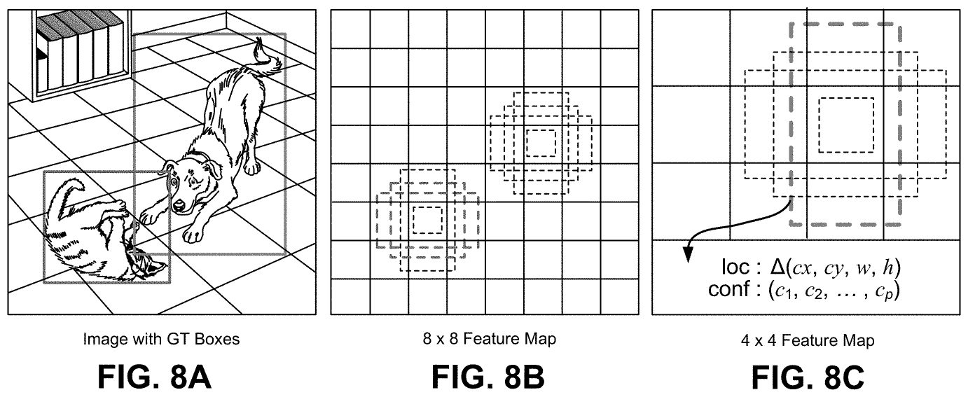

Another deep learning-based detector that can be used by the object detector 202 to detect or classify objects in image frames includes the SSD detector, which is a fast single-shot object detector that can be applied for multiple object categories or classes. The SSD model uses multi-scale convolutional bounding box outputs attached to multiple feature maps at the top of the neural network. Such a representation allows the SSD to efficiently model diverse box shapes. FIG. 8A includes an image frame and FIG. 8B and FIG. 8C include diagrams illustrating how an SSD detector (with the VGG deep network base model) operates. For example, SSD matches objects with default boxes of different aspect ratios (shown as dashed rectangles in FIG. 8B and FIG. 8C). Each element of the feature map has a number of default boxes associated with it. Any default box with an intersection-over-union with a ground truth box over a threshold (e.g., 0.4, 0.5, 0.6, or other suitable threshold) is considered a match for the object. For example, two of the 8×8 boxes (shown in blue in FIG. 8B) are matched with the cat, and one of the 4×4 boxes (shown in red in FIG. 8C) is matched with the dog. SSD has multiple features maps, with each feature map being responsible for a different scale of objects, allowing it to identify objects across a large range of scales. For example, the boxes in the 8×8 feature map of FIG. 8B are smaller than the boxes in the 4×4 feature map of FIG. 8C. In one illustrative example, an SSD detector can have six feature maps in total.

For each default box in each cell, the SSD neural network outputs a probability vector of length c, where c is the number of classes, representing the probabilities of the box containing an object of each class. In some cases, a background class is included that indicates that there is no object in the box. The SSD network also outputs (for each default box in each cell) an offset vector with four entries containing the predicted offsets required to make the default box match the underlying object's bounding box. The vectors are given in the format (cx, cy, w, h), with cx indicating the center x, cy indicating the center y, w indicating the width offsets, and h indicating height offsets. The vectors are only meaningful if there actually is an object contained in the default box. For the image frame shown in FIG. 8A, all probability labels would indicate the background class with the exception of the three matched boxes (two for the cat, one for the dog).

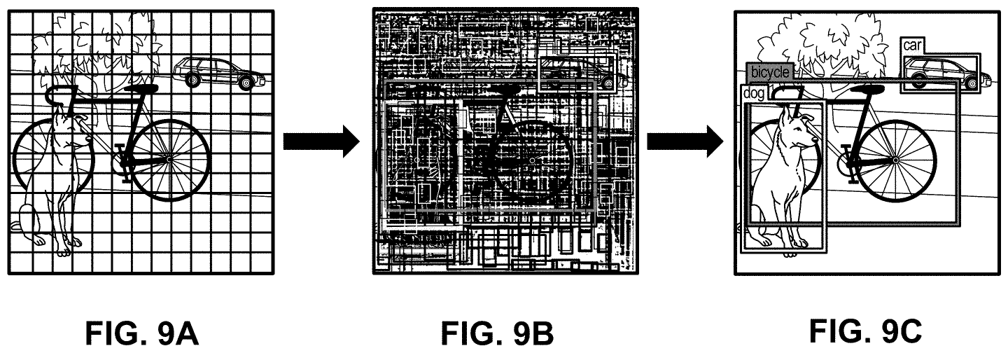

Another deep learning-based detector that can be used by the object detector 202 to detect or classify objects in image frames includes the You only look once (YOLO) detector, which is an alternative to the SSD object detection system. FIG. 9A includes an image frame and FIG. 9B and FIG. 9C include diagrams illustrating how the YOLO detector operates. The YOLO detector can apply a single neural network to a full image frame. As shown, the YOLO network divides the image frame into regions and predicts bounding boxes and probabilities for each region. These bounding boxes are weighted by the predicted probabilities. For example, as shown in FIG. 9A, the YOLO detector divides up the image frame into a grid of 13-by-13 cells. Each of the cells is responsible for predicting five bounding boxes. A confidence score is provided that indicates how certain it is that the predicted bounding box actually encloses an object. This score does not include a classification of the object that might be in the box, but indicates if the shape of the box is suitable. The predicted bounding boxes are shown in FIG. 9B. The boxes with higher confidence scores have thicker borders.

Each cell also predicts a class for each bounding box. For example, a probability distribution over all the possible classes is provided. Any number of classes can be detected, such as a bicycle, a dog, a cat, a person, a car, or other suitable object class. The confidence score for a bounding box and the class prediction are combined into a final score that indicates the probability that that bounding box contains a specific type of object. For example, the yellow box with thick borders on the left side of the image frame in FIG. 9B is 85% sure it contains the object class “dog.” There are 169 grid cells (13×13) and each cell predicts 5 bounding boxes, resulting in 945 bounding boxes in total. Many of the bounding boxes will have very low scores, in which case only the boxes with a final score above a threshold (e.g., above a 30% probability, 40% probability, 50% probability, or other suitable threshold) are kept. FIG. 9C shows an image frame with the final predicted bounding boxes and classes, including a dog, a bicycle, and a car. As shown, from the 945 total bounding boxes that were generated, only the three bounding boxes shown in FIG. 9C were kept because they had the best final scores.

In some examples, the detection or classification outputs generated by the object detector 202 are provided to the object controller 204, for example, to determine if a tracking algorithm should be instantiated to assist with the detection process. As illustrated in the example of FIG. 2, the object controller 204 can include a detector analyzer 206, a tracker controller 208, and an object processor 210. As noted above, the outputs from the object detector 202 can include information indicating a region of interest (ROI) and a confidence (e.g., a confidence level or score) with respect to a given object or portion of an object that is detected within an image frame (e.g., within the ROI). For instance, an output from object detector 202 may indicate an ROI and a numeric confidence that a face is detected within an image frame, or a portion of an image frame, using a quantitative score. In one illustrative example, the quantitative score of the numeric confidence can be within the interval [0, 1], such as a confidence or score of 0.6, 0.7, 0.8, etc.

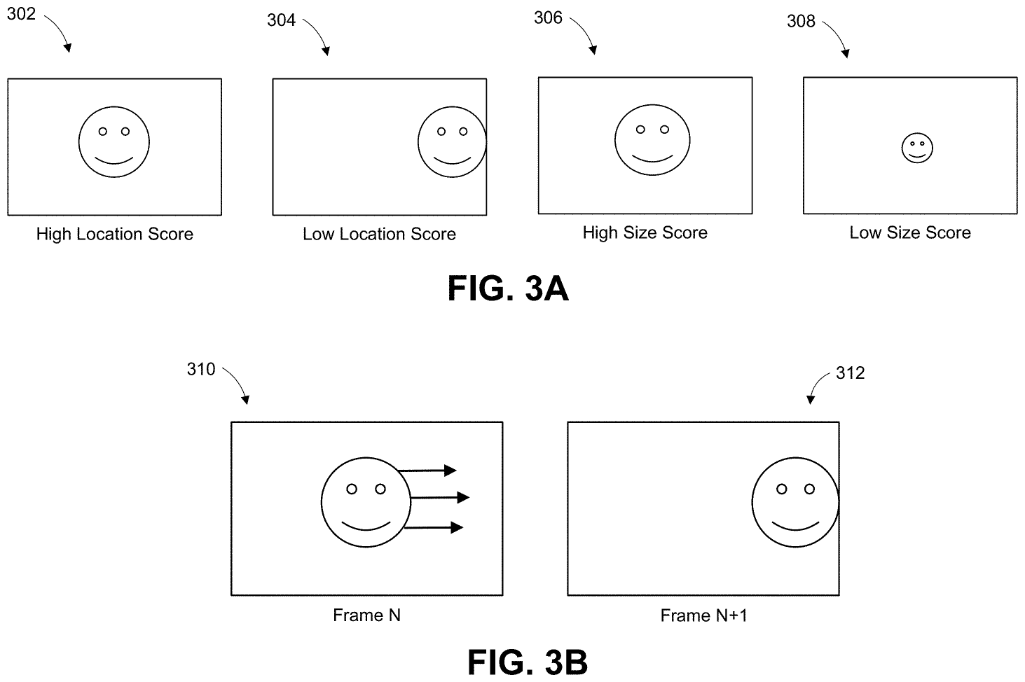

The detector analyzer 206 can be configured to receive the output from the object detector 202. Based on the output, the detector analyzer 206 can be configured to determine/calculate a validation score based on the ROI. In some examples, the validation score can be a value (e.g., a normalized value) between 0 and 1. In some aspects, the detector analyzer 206 can evaluate and/or calculate a validation score for an ROI (e.g., included as part of an object detection result from the object detector 202) or respective validation scores for each ROI of multiple ROIs detected in an image frame based on a variety of factors. In some cases, the validation score can be based on the size of the ROI (e.g., the size of a bounding box or other bounding region representing the ROI), the confidence score provided by the object detector 202, motion vector information associated with an object corresponding with the ROI, the location of the ROI within the image frame, any combination thereof, and/or other information. As noted above, in some examples, the detection or classification output from the object detector 202 can include the size of the ROI, the location of the ROI within the image frame, and/or the motion vector information associated with an object corresponding with the ROI. In other examples, the detector analyzer 206 or other component of the object controller 204 can determine the size of the ROI, the location of the ROI within the image frame, and/or the motion vector information. Further details regarding validation score calculations performed by the detector analyzer 206 are discussed with respect to FIGS. 3A and 3B, below.

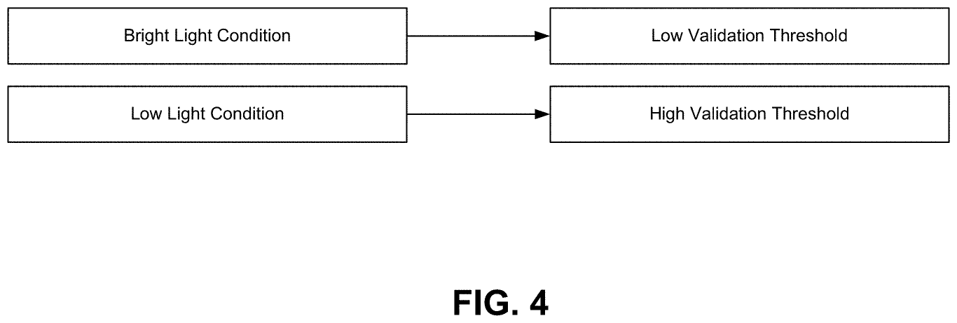

In some implementations, the detector analyzer 206 can be configured to determine if object tracking should be performed (e.g., for a detected object in one or more image frames) based on the validation score. For example, the detector analyzer 206 can compare the validation score with a validation threshold (which can be a pre-determined threshold or dynamically determined threshold) to determine if the image frame should be provided directly to an object processor 210, or if tracking should be performed for one or more ROIs in the image frame. In some implementations, the validation threshold can be dynamic; for example, the validation threshold may be set based on the quality of the image, as discussed in further detail with respect to FIG. 4 below. In one illustrative example, the validation threshold can be a value between 0 and 1, such as 0.7, 0.75, 0.8, or other suitable value.

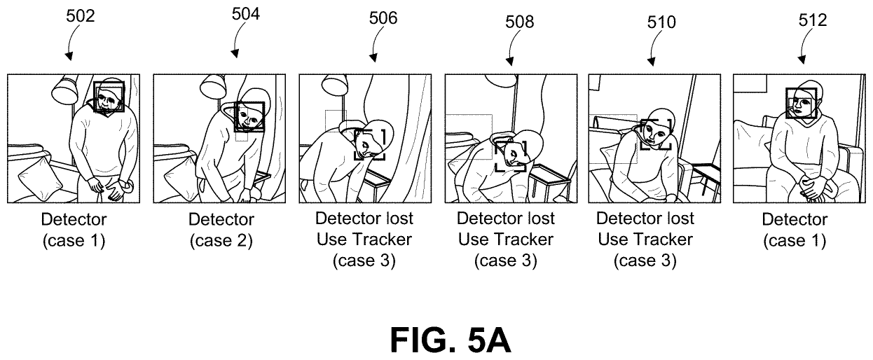

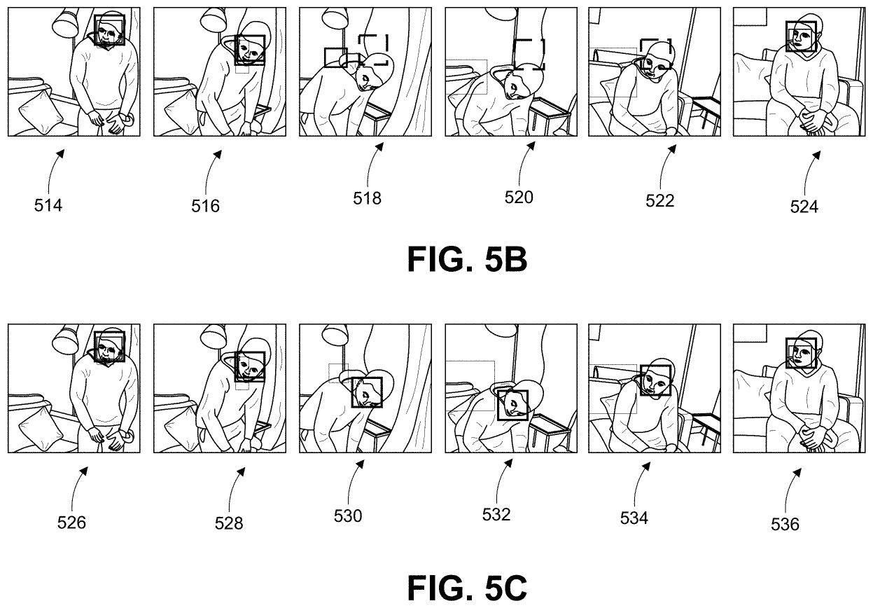

In some examples, if it is determined by the detector analyzer 206 that the validation score is greater than (or equal to in some cases) the validation threshold, then the image frame may be provided directly to the object processor 210. Alternatively, if it is determined that the validation score is less than (or equal to in some cases) the validation threshold, then the image frame may be provided to a tracker controller 208. In some examples, the tracker controller 208 can be configured to instantiate or evoke a tracking engine 212 to apply a tracking algorithm, for example, to perform tracking on an object corresponding to an ROI in the image frame or to perform tracking of multiple objects corresponding to one or more ROIs in the image frame. Further details regarding the tracking performed for a given ROI are provided with respect to FIGS. 5A-5C, discussed below.

The tracking engine 212 can provide (e.g., transmit, output, etc.) the tracking results/outputs to the object processor 210. In some cases, the tracking results/outputs can include information associated with a bounding region (e.g., a bounding box) for the tracking results, confidence score or level (e.g., a value within an interval or range of [0, 1]) associated with the tracking results, and/or other information. In some cases, as described herein, the tracking output can be output from the object controller 204. For example, the outputs from the object processor 210 can be provided for use by one or more image processing operations performed by an image processing engine 214, so that the tracking result can be used for further image processing. For example, the results of the combined object detection and tracking may be used to calibrate image acquisition parameters, such as zoom adjustments, or other types of image processing and/or image capture calibration. In some cases, the image processing engine 214 can be part of an image capture device, which can be part of a vehicle, a camera, a mobile device, an XR device, or other device. The image processing operations can include one or more 3A operations such as auto-focus, auto-exposure, auto-white-balance, auto-zoom, blurring a region of the image frame outside of the ROI (which can be referred to as bokeh, etc.).

Using the information output from the detector analyzer 206 and the tracker controller 208, the object processor 210 can determine the output for an object associated with a particular ROI. In one illustrative example, if it is determined that the detection result (from the object detector 202) is valid (e.g., greater than or equal to the validation threshold) and has a high confidence score (e.g., greater than or equal to a confidence threshold, such as 0.7, 0.8, or other suitable value), the object processor 210 can use the detection result from the object detector 202 as the output to the image processing engine 214 for performing the one or more image processing operations. In another illustrative example, if it is determined that the detection result is valid (e.g., greater than or equal to the validation threshold) but has a low confidence value (e.g., less than the confidence threshold), the object processor 210 can compare the result (e.g., the bounding box) from the object detector 202 and the result (e.g., the bounding box) from the tracking engine 212 and can output a combination result (e.g., a combined bounding box). The combination result (or combined result) can include any suitable combination of the detection and tracking results. In some cases, the type of combination result can depend on one or more factors, such as whether there is overlap between a bounding box from the object detection and a bounding box from the object tracker. In one example, if there is overlap between a bounding box from the object detector 202 and a bounding box from the object tracking engine 212, the combination result can include a combined bounding box that includes a union of the bounding box from the object detector 202 and the bounding box from the object tracking engine 212. In another example, if there is no overlap between a bounding box from the object detector 202 and a bounding box from the object tracking engine 212, the bounding box from the object detector 202 or the bounding box from the tracking engine 212 with the highest confidence can be selected as the output.

In another illustrative example, if it is determined that the detection result is invalid (e.g., less than the validation threshold), the object processor 210 can use the tracker result from the tracking engine 212 as the detection output to the image processing engine 214 for performing the one or more image processing operations (e.g., auto-focus, auto-white balance, auto-exposure, auto-zoom, etc.). In another illustrative example, if it is determined that the detection result and the tracker result are invalid, the object processor 210 can determine that no object output will be provided for the object associated with the ROI.

FIGS. 3A and 3B illustrate examples in which a detector analyzer is used to produce a validation score based on different image characteristics, according to some aspects of the disclosed technology. As discussed above, the validation score can be based on a location of the identified ROI/object. As illustrated in the examples of frames 302 and 304, validation scores for ROIs/objects located more centrally in the image frame (e.g., frame 302) may be higher (e.g., a higher location score) than for those in which the ROIs/objects are located away from the center of the image frame (e.g., frame 304). In some aspects, this scoring difference can be based on the likelihood of an occlusion with respect to the object, whereby higher likelihoods of object occlusion are assumed for peripheral object placements (frame 304), as opposed to more central object placements (frame 302).

Additionally, ROIs/objects that are greater in relative size within an image frame may be given higher validation scores than for those that appear to be smaller within the image frame. Further to the example of FIG. 3A, the ROI/object in frame 306 may be given a greater relative validation score (e.g., a higher size score), as compared with that of frame 308, which includes a smaller object. In some implementations, the validation score may also be based on motion vector information. As illustrated in the example of FIG. 3B, an object/ROI in frame 310 that is determined to have a large motion vector (e.g., indicating that the object/ROI may move outside of the image frame in successive frames, such as shown in frame 312) may be given a lower validation score (e.g., so that object tracking is initiated), as discussed above with respect to FIG. 2. The resulting validation score for a particular image frame or ROI/object can be evaluated using a validation threshold to determine if a tracking algorithm should be invoked. As discussed above, the validation threshold can be pre-determined or dynamic, and can be based on various image properties, as illustrated with respect to FIG. 4.

FIG. 4 conceptually illustrates an example of how dynamic threshold assignments can be performed using a tracker controller (e.g., based on lighting conditions of a corresponding image frame). In some aspects, image frames associated with brighter lighting conditions (e.g., higher average lumen values) may be given lower validation thresholds. In such approaches, the object tracking algorithms are less likely to be invoked for subsequent image frames. In another example, image frames associated with lower (dimmer) lighting conditions (e.g., lower average lumen values) may be given higher validation thresholds (e.g., to increase the likelihood that object tracking is invoked).

FIG. 5A illustrates examples of how region of interest (ROI) outputs can be used by an object processor (e.g., the object processor 210 of FIG. 2), depending on the information provided by the detector analyzer (e.g., the detector analyzer 206 of FIG. 2) and/or the tracker controller (e.g., the tracker controller 208 of FIG. 2), according to some aspects of the disclosed technology. In the example of frames 502 and 512, if the validation score output of the detector analyzer (e.g., detector analyzer 206) indicates that the object detection result is high confidence and valid, then the output of the object detector can be selected by the object processor for use by an image processing engine (e.g., the image processing engine 214 of FIG. 2). In the example of frame 504, if the validation score of the detector is valid, but the detection result has low confidence, then a comparison can be made between the object detector and the tracking engine (e.g., between a bounding box output by the object detector 202 and a bounding box output by the object detector 202). As described above, based on the comparison, a combination result (e.g., a combined bounding box) or the bounding box with the highest confidence can be selected by the object processor. In the example of frames 506, 508, 510, if it is determined that the result of the object detector is invalid (low validation score), then the results (e.g., the bounding box) of the tracking engine can be used by the object processor.

FIG. 5B and FIG. 5C illustrate examples of region of interest (ROI) outputs generated by an object processor using a conventional tracking system (FIG. 5B) and a hybrid object detection and tracking system (FIG. 5C), respectively. In particular, FIG. 5B illustrates the placement of ROIs (bounding boxes) in various frames (including frames 514, 516, 518, 520, 522, and 524) using an object detection approach in which tracking is not performed. In the example of FIG. 5B, it can be noted that ROI placement can be performed sufficiently well for those frames in which the object of interest is clearly visible in the image frame, e.g., at frames 514, 516, and 524. However, once object detection fails (or is of low confidence), due to poor visibility of the object within the ROI (e.g., at frames 518, 520, 522), then the result of object tracking does not perform well (e.g., the ROI at frames 518, 520, and 522 is placed at a static location despite the dynamic location of the object such as a face that is being determined/tracked). However, in the example of FIG. 5C, adequate tracking can be accomplished in the corresponding frames (e.g., frames 530, 532, 534) using the additional information provided by the tracking algorithm (e.g., in a hybrid object detection and tracking approach, such as using the hybrid object detection and tracking system 200). Objection detection (e.g., face detection) is also shown in frames 526, 528, and 536.

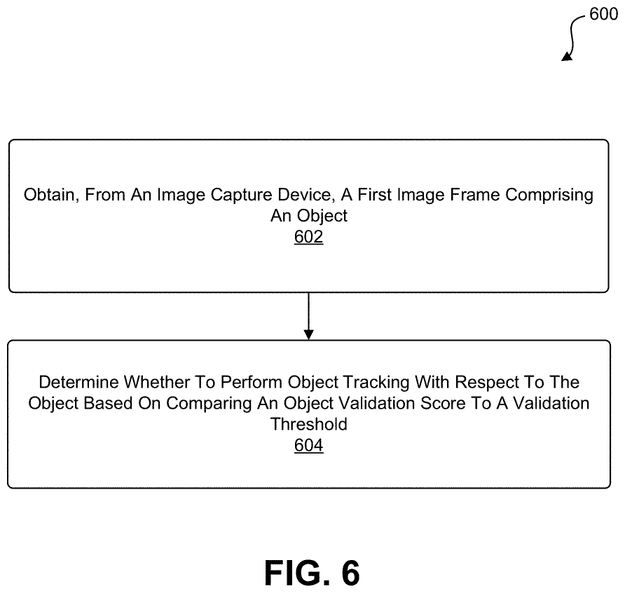

FIG. 6 illustrates steps of an example process 600 for implementing a hybrid object detection and tracking system, according to some aspects of the disclosed technology. At block 602, the process 600 includes obtaining, from an image capture device, a first image frame comprising an object.

At block 604, the process 600 includes determining whether to perform object tracking with respect to the object based on comparing an object validation score to a validation threshold. The object validation score is associated with detection of the object in the first image frame. In some cases, the process 600 can include determining, using an object detector, the object validation score associated with detection of the object in the first image frame. In some cases, the process 600 can include comparing, using a detector analyzer, the object validation score to the validation threshold. In some aspects, the validation score is based on a size of the object in the first image frame, a distance of the object from a center of the first image frame, a combination of the size and the distance, and/or any other factors, such as those described herein. In some aspects, the validation threshold is automatically configured based on one or more image properties associated with the first image frame. In some cases, the one or more image properties include an image brightness level.

In some aspects, the process 600 can include determining the object validation score is less than the validation threshold. Based on the object validation score being less than the validation threshold, the process 600 can include tracking the object for one or more image frames received subsequent to the first image frame. In some cases, the process 600 can include processing at least one image frame of the one or more image frames based on tracking the object, such as based on a region of interest (ROI) generated based on tracking the object. For example, as described above, if the detection result is determined to be invalid (e.g., less than the validation threshold), the object process 210 can output a tracking result for use as an object detection output for use by one or more image processing or capture operations (e.g., auto-focus, auto-exposure, auto-white-balance, auto-zoom, etc.). In another example, if it is determined that the detection result is valid but has low confidence (e.g., greater than the validation threshold and less than the confidence threshold), the process 600 can compare the result between detector and tracker and can output a combined result (e.g., a union of a bounding box from the object detection and a bounding box from the object tracker). In some aspects, once the detection result is determined, the process 600 can include obtaining a second image frame including the object or an additional object and determining an additional object validation score associated with detection of the object or the additional object in the second image frame is greater than the validation threshold. Based on the additional object validation score being greater than the validation threshold, the process 600 can include processing the second image frame based on detection of the object (e.g., based on an ROI generated based on detection of the object).

In some examples, the process 600 can include determining the object validation score associated with detection of the object in the first image frame is greater than the validation threshold. Based on the object validation score being greater than the validation threshold, the process 600 can include processing the first image frame based on detection of the object (e.g., using an object processor), such as based on an ROI generated based on detection of the object. For example, as described above, if the detection result (based on detection of the object) is determined to be valid (e.g., greater than the validation threshold), the object processor 210 can output the detection result. In some cases, the process 600 can include processing the first image frame using an object processor based on the object validation score being greater than the validation threshold and also based on detection of the object (the detection result) having a high confidence (e.g., greater than a confidence threshold, such as 0.7).

In some aspects, the process 600 can include adjusting a setting of the image capture device based on the first image frame and a tracking output based on tracking of the object (e.g., if the validation score associated with the detection result is less than the validation threshold and/or the confidence of the detection result is less than the confidence threshold). In some examples, the setting is adjusted based on an ROI associated with the object. In some cases, the ROI is based on tracking the object for the one or more image frames, in which case the tracking-based ROI can be used to adjust the setting. In some cases, the ROI is based on detection of the object in the first image frame, in which case the object tracking-based ROI can be used to adjust the setting. In some examples, the setting is adjusted based on a first ROI associated with the object and a second ROI associated with the object. In some cases, the first ROI can be based on tracking the object for the one or more image frames and the second ROI can be based on detection of the object in the first image frame, in which case the tracking-based ROI and the detection-based ROI can be used to adjust the setting. For example, as described above, a combination result (e.g., a combined bounding box) or the bounding box with the highest confidence can be selected by the object processor. Alternatively or in addition, in some examples, the setting includes at least one of an auto-focus setting, an auto-exposure setting, and an auto-white-balance setting. Alternatively or in addition, in some examples, the setting includes a segmentation process.

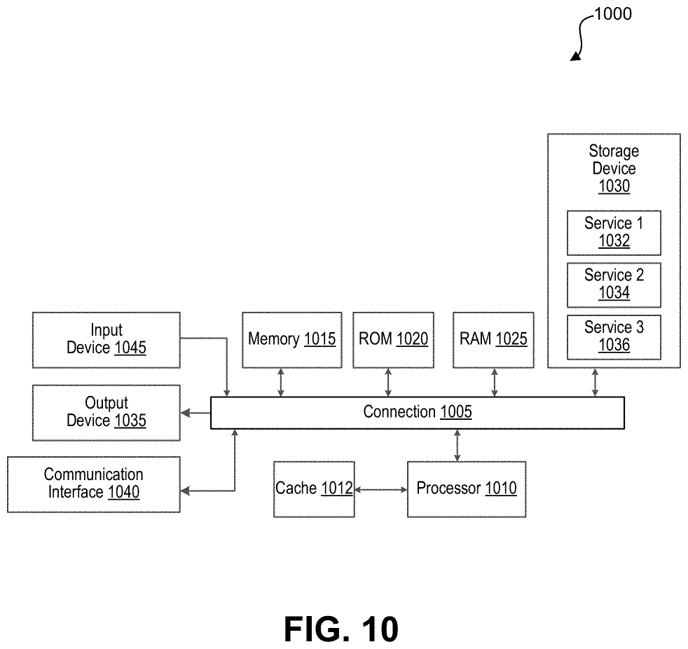

In some examples, the processes described herein (e.g., process 600 and/or other process described herein) may be performed by a computing device or apparatus (e.g., the object controller 204 of FIG. 2, the hybrid object detector and tracker system 200 of FIG. 2, the image capture and processing system 100 of FIG. 1, a computing device with the computing system 1000 of FIG. 10, or other device). For instance, a computing device with the computing architecture shown in FIG. 10 can include the components of the object controller 204 of FIG. 2 and can implement the operations of FIG. 6.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein, including the process 600. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 600 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 600, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 10 is a diagram illustrating an example of a system for implementing certain aspects of the present technology. In particular, FIG. 10 illustrates an example of computing system 1000, which can be for example any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some embodiments, computing system 1000 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1000 includes at least one processing unit (CPU or processor) 1010 and connection 1005 that couples various system components including the memory unit 1015, such as read-only memory (ROM) 1020 and random access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000. Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some embodiments, a hardware service that performs a particular function can include the software component stored in a computer-readable medium in connection with the necessary hardware components, such as processor 1010, connection 1005, output device 1035, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the present disclosure include:

Aspect 1: A method for processing image data, comprising: obtaining, from an image capture device, a first image frame comprising an object; and determining whether to perform object tracking with respect to the object based on comparing an object validation score to a validation threshold, wherein the object validation score is associated with detection of the object in the first image frame.

Aspect 2: The method of aspect 1, further comprising: determining, using an object detector, the object validation score associated with detection of the object in the first image frame.

Aspect 3: The method of any one of aspects 1 or 2, further comprising: comparing, using a detector analyzer, the object validation score to the validation threshold.

Aspect 4: The method of any one of aspects 1 to 3, further comprising: determining the object validation score is greater than the validation threshold; and based on the object validation score being greater than the validation threshold, processing the first image frame using an object processor.

Aspect 5: The method of any one of aspects 1 to 3, further comprising: determining the object validation score is less than the validation threshold; and based on the object validation score being less than the validation threshold, tracking the object for one or more image frames received subsequent to the first image frame.

Aspect 6: The method of aspect 5, further comprising: adjusting a setting of the image capture device based on the first image frame and a tracking output based on tracking of the object.

Aspect 7: The method of aspect 6, wherein the setting is adjusted based on a region of interest (ROI) associated with the object.

Aspect 8: The method of any one of aspects 6 or 7, wherein the setting includes at least one of an auto-focus setting, an auto-exposure setting, and an auto-white-balance setting.

Aspect 9: The method of any one of aspects 6 to 8, wherein the setting includes a segmentation process.

Aspect 10: The method of any one of aspects 1 to 9, wherein the object validation score is based on at least one of a size of the object in the first image frame and a distance of the object from a center of the first image frame.

Aspect 11: The method of any one of aspects 1 to 10, wherein the validation threshold is automatically configured based on one or more image properties associated with the first image frame.

Aspect 12: The method of aspect 11, wherein the one or more image properties include an image brightness level.

Aspect 13: An apparatus for processing image data, the apparatus comprising: at least one memory: at least one processor coupled to the at least one memory, the at least one processor configured to: obtain, from an image capture device, a first image frame comprising an object; and determine whether to perform object tracking with respect to the object based on comparing the object validation score to the validation threshold, wherein the object validation score is associated with detection of the object in the first image frame.

Aspect 14: The apparatus of aspect 13, wherein the at least one processor is configured to: determine, using an object detector, the object validation score associated with the object in the first image frame.

Aspect 15: The apparatus of any one of aspects 13 or 14, wherein the at least one processor is configured to: compare, using a detector analyzer, the object validation score to the validation threshold.

Aspect 16: The apparatus of any one of aspects 13 to 15, wherein the at least one processor is configured to: determine the object validation score is greater than the validation threshold; and based on the object validation score being greater than the validation threshold, processing the first image frame using an object processor.

Aspect 17: The apparatus of any one of aspects 13 to 15, wherein the at least one processor is configured to: determine the object validation score is less than the validation threshold; and based on the object validation score being less than the validation threshold, tracking the object for one or more image frames received subsequent to the first image frame.

Aspect 18: The apparatus of aspect 17, wherein the at least one processor is configured to: adjust a setting of the image capture device based on the first image frame and a tracking output based on tracking of the object.

Aspect 19: The apparatus of aspect 18, wherein the at least one processor is configured to adjust the setting based on a region of interest (ROI) associated with the object.

Aspect 20: The apparatus of any one of aspects 18 or 19, wherein the setting includes at least one of an auto-focus setting, an auto-exposure setting, and an auto-white-balance setting.

Aspect 21: The apparatus of any one of aspects 18 to 20, wherein the setting includes a segmentation process.

Aspect 22: The apparatus of any one of aspects 13 to 21, wherein the object validation score is based on at least one of a size of the object in the first image frame and a distance of the object from a center of the first image frame.

Aspect 23: The apparatus of any one of aspects 13 to 21, wherein the validation threshold is automatically configured based on one or more image properties corresponding with the first image frame.

Aspect 24: The apparatus of aspect 23, wherein the one or more image properties include an image brightness level.

Aspect 25: A non-transitory computer-readable storage medium comprising instructions stored thereon which, when executed by one or more processors, cause the one or more processors to perform operations of any of aspects 1 to 24.

Aspect 26: An apparatus for processing image data, the apparatus comprising means for performing operations of any of aspects 1 to 24.

Aspect 27: A method for processing image data, comprising: obtaining, from an image capture device, a first image frame comprising an object; determining, using an object detector, an object validation score associated with detection of the object in the first image frame; determining the object validation score is less than a validation threshold; and based on the object validation score being less than the validation threshold, tracking the object for one or more image frames received subsequent to the first image frame.

Aspect 28: The method of Aspect 27, further comprising: comparing, using a detector analyzer, the object validation score to the validation threshold, wherein determining the object validation score is less than the validation threshold is based on the comparison.

Aspect 29: The method of any of Aspects 27 or 28, further comprising: obtaining a second image frame comprising the object or an additional object; determining an additional object validation score associated with detection of the object or the additional object in the second image frame is greater than the validation threshold; and based on the additional object validation score being greater than the validation threshold, processing the second image frame based on detection of the object.

Aspect 30: The method of any of Aspects 27 to 29, further comprising: adjusting a setting of the image capture device based on the first image frame and a tracking output based on tracking of the object.

Aspect 31: The method of Aspect 30, wherein the setting is adjusted based on a region of interest (ROI) associated with the object.

Aspect 32: The method of Aspect 31, wherein the ROI is based on tracking the object for the one or more image frames.

Aspect 33: The method of any of Aspects 31 or 32, wherein the ROI is based on detection of the object in the first image frame.

Aspect 34: The method of Aspect 30, wherein the setting is adjusted based on a first region of interest (ROI) associated with the object and a second ROI associated with the object.

Aspect 35: The method of Aspect 34, wherein the first ROI is based on tracking the object for the one or more image frames, and wherein the second ROI is based on detection of the object in the first image frame.

Aspect 36: The method of any of Aspects 30 to 35, wherein the setting includes at least one of an auto-focus setting, an auto-exposure setting, and an auto-white-balance setting.

Aspect 37: The method of any of Aspects 30 to 36, wherein the setting includes a segmentation process.

Aspect 38: The method of any of Aspects 27 to 37, wherein the object validation score is based on at least one of a size of the object in the first image frame and a distance of the object from a center of the first image frame.

Aspect 39: The method of any of Aspects 27 to 38, wherein the validation threshold is automatically configured based on one or more image properties associated with the first image frame.

Aspect 40: The method of any of Aspects 27 to 39, wherein the one or more image properties include an image brightness level.

Aspect 41: An apparatus for processing image data, the apparatus comprising: at least one memory: at least one processor coupled to the at least one memory, the at least one processor configured to: obtain, from an image capture device, a first image frame comprising an object; determine, using an object detector, an object validation score associated with detection of the object in the first image frame; determine the object validation score is less than a validation threshold; and based on the object validation score being less than the validation threshold, tracking the object for one or more image frames received subsequent to the first image frame.

Aspect 42: The apparatus of Aspect 41, wherein the at least one processor is configured to: compare, using a detector analyzer, the object validation score to the validation threshold; and determine the object validation score is less than the validation threshold based on the comparison.

Aspect 43: The apparatus of any of Aspects 41 or 42, wherein the at least one processor is configured to: obtain a second image frame comprising the object or an additional object; determine an additional object validation score associated with detection of the object or the additional object in the second image frame is greater than the validation threshold; and based on the additional object validation score being greater than the validation threshold, process the second image frame based on detection of the object.

Aspect 44: The apparatus of any of Aspects 41 to 43, wherein the at least one processor is configured to: adjust a setting of the image capture device based on the first image frame and a tracking output based on tracking of the object.

Aspect 45: The apparatus of Aspect 44, wherein the at least one processor is configured to adjust the setting based on a region of interest (ROI) associated with the object.

Aspect 46: The apparatus of Aspect 45, wherein the ROI is based on tracking the object for the one or more image frames.

Aspect 47: The apparatus of any of Aspects 45 or 46, wherein the ROI is based on detection of the object in the first image frame.

Aspect 48: The apparatus of Aspect 44, wherein the at least one processor is configured to adjust the setting based on a first region of interest (ROI) associated with the object and a second ROI associated with the object.

Aspect 49: The apparatus of Aspect 49, wherein the first ROI is based on tracking the object for the one or more image frames, and wherein the second ROI is based on detection of the object in the first image frame.

Aspect 50: The apparatus of any of Aspects 44 to 49, wherein the setting includes at least one of an auto-focus setting, an auto-exposure setting, and an auto-white-balance setting.

Aspect 51: The apparatus of any of Aspects 44 to 50, wherein the setting includes a segmentation process.

Aspect 52: The apparatus of any of Aspects 41 to 51, wherein the object validation score is based on at least one of a size of the object in the first image frame and a distance of the object from a center of the first image frame.

Aspect 53: The apparatus of any of Aspects 41 to 52, wherein the validation threshold is automatically configured based on one or more image properties corresponding with the first image frame.

Aspect 54: The apparatus of any of Aspects 41 to 53, wherein the one or more image properties include an image brightness level.

Aspect 55: The apparatus of any of Aspects 41 to 54, wherein the apparatus comprises at least one camera configured to capture the first image frame.

Aspect 56: A non-transitory computer-readable storage medium comprising instructions stored thereon which, when executed by one or more processors, cause the one or more processors to perform operations of any of aspects 27 to 55.

Aspect 57: An apparatus for processing image data, the apparatus comprising means for performing operations of any of aspects 27 to 55.

What is claimed is:

1. A method for processing image data, comprising:
obtaining, from an image capture device, a first image frame comprising an object;
determining, using an object detector, an object validation score associated with detection of the object in the first image frame;
determining the object validation score is less than a validation threshold; and
based on the object validation score being less than the validation threshold, tracking the object for one or more image frames received subsequent to the first image frame.

2. The method of claim 1, further comprising:
comparing, using a detector analyzer, the object validation score to the validation threshold, wherein determining the object validation score is less than the validation threshold is based on the comparison.

3. The method of claim 1, further comprising:
obtaining a second image frame comprising the object or an additional object;
determining an additional object validation score associated with detection of the object or the additional object in the second image frame is greater than the validation threshold; and
based on the additional object validation score being greater than the validation threshold, processing the second image frame based on detection of the object.

4. The method of claim 1, further comprising:
adjusting a setting of the image capture device based on the first image frame and a tracking output based on tracking of the object.

5. The method of claim 4, wherein the setting is adjusted based on a region of interest (ROI) associated with the object.

6. The method of claim 5, wherein the ROI is based on tracking the object for the one or more image frames.

7. The method of claim 5, wherein the ROI is based on detection of the object in the first image frame.

8. The method of claim 4, wherein the setting is adjusted based on a first region of interest (ROI) associated with the object and a second ROI associated with the object.

9. The method of claim 8, wherein the first ROI is based on tracking the object for the one or more image frames, and wherein the second ROI is based on detection of the object in the first image frame.

10. The method of claim 4, wherein the setting includes at least one of an auto-focus setting, an auto-exposure setting, and an auto-white-balance setting.

11. The method of claim 4, wherein the setting includes a segmentation process.

12. The method of claim 1, wherein the object validation score is based on at least one of a size of the object in the first image frame and a distance of the object from a center of the first image frame.

13. The method of claim 1, wherein the validation threshold is automatically configured based on one or more image properties associated with the first image frame.

14. The method of claim 13, wherein the one or more image properties include an image brightness level.

15. An apparatus for processing image data, the apparatus comprising:
at least one memory:
at least one processor coupled to the at least one memory, the at least one processor configured to:
obtain, from an image capture device, a first image frame comprising an object;
determine, using an object detector, an object validation score associated with detection of the object in the first image frame;
determine the object validation score is less than a validation threshold; and
based on the object validation score being less than the validation threshold, tracking the object for one or more image frames received subsequent to the first image frame.

16. The apparatus of claim 15, wherein the at least one processor is configured to:
compare, using a detector analyzer, the object validation score to the validation threshold; and
determine the object validation score is less than the validation threshold based on the comparison.

17. The apparatus of claim 15, wherein the at least one processor is configured to:
obtain a second image frame comprising the object or an additional object;
determine an additional object validation score associated with detection of the object or the additional object in the second image frame is greater than the validation threshold; and
based on the additional object validation score being greater than the validation threshold, process the second image frame based on detection of the object.

18. The apparatus of claim 15, wherein the at least one processor is configured to:
adjust a setting of the image capture device based on the first image frame and a tracking output based on tracking of the object.

19. The apparatus of claim 18, wherein the at least one processor is configured to adjust the setting based on a region of interest (ROI) associated with the object.

20. The apparatus of claim 19, wherein the ROI is based on tracking the object for the one or more image frames.

21. The apparatus of claim 19, wherein the ROI is based on detection of the object in the first image frame.

22. The apparatus of claim 18, wherein the at least one processor is configured to adjust the setting based on a first region of interest (ROI) associated with the object and a second ROI associated with the object.

23. The apparatus of claim 22, wherein the first ROI is based on tracking the object for the one or more image frames, and wherein the second ROI is based on detection of the object in the first image frame.

24. The apparatus of claim 18, wherein the setting includes at least one of an auto-focus setting, an auto-exposure setting, and an auto-white-balance setting.

25. The apparatus of claim 18, wherein the setting includes a segmentation process.

26. The apparatus of claim 15, wherein the object validation score is based on at least one of a size of the object in the first image frame and a distance of the object from a center of the first image frame.

27. The apparatus of claim 15, wherein the validation threshold is automatically configured based on one or more image properties corresponding with the first image frame.

28. The apparatus of claim 27, wherein the one or more image properties include an image brightness level.

29. The apparatus of claim 15, wherein the apparatus comprises at least one camera configured to capture the first image frame.

30. A non-transitory computer-readable storage medium comprising instructions stored thereon which, when executed by one or more processors, cause the one or more processors to:
obtain, from an image capture device, a first image frame comprising an object;
determine, using an object detector, an object validation score associated with detection of the object in the first image frame;
determine the object validation score is less than a validation threshold; and
based on the object validation score being less than the validation threshold, track the object for one or more image frames received subsequent to the first image frame.
